(19) United States
(12) Patent Application Publication
(10) Pub. No.: US 2009/0070466 A1
(43) Pub. Date: Mar. 12, 2009

(54) System and Method for Securely Managing Data in a Client-Server Application Environment

(75) Inventor: Christopher R. Elbring, St. Louis, MO (US)

Correspondence Address: CROWELL & MORING LLP;INTELLECTUAL PROPERTY GROUP, P.O. BOX 14300, WASHINGTON, DC, 20044-4300, US

(73) Assignee: SecureAxis Software, LLC, St. Louis, MO (US)

(21) Appl. No.: 11/850,806

(22) Filed: Sep. 6, 2007

(51) Int. Cl. G06F 21/20

(52) U.S. Cl. 709/225

(57) ABSTRACT

Systems and methods for securely managing data in a client-server application environment are provided. According to a method for securely managing data in the client-server environment, a network connection of a client device is monitored. It is determined when one of a plurality of IP addresses is accessed by the client device, and a process ID of the application (web browser, thin-client, etc.) used to access the accessed IP address is sent to a client application. A criteria is created based on the process ID, and the criteria is sent to a file system driver for controlling access of the client device to information from the IP address.

### BACKGROUND OF THE INVENTION

The present invention relates generally to secure management of data and, more particularly, to systems and methods for securely managing data in a client-server application environment.

Client-server computing, in which client computers having minimal processing and storage capabilities are dependent upon a client server, is becoming more popular. However, client-server computing environments use software that is often outside of the protective range of a company (e.g., outside the firewall), being accessible only via a network connection such as the Internet. Therefore, a need exists to securely manage data in a client-server application environment.

### SUMMARY OF THE INVENTION

Exemplary embodiments of the present invention provide systems and methods for securely managing data in a client-server application environment. A system for securely managing data in the client-server environment includes a network that connects devices in the client-server environment including a client application, a thick client application or an internet browser application configured to access the network, a server configured to provide applications and drivers to clients in the client-server environment, and a client including a client application configured to provide criteria including a plurality of IP addresses to a network driver. The network driver monitors network connections of the client applications to determine when one of the plurality of IP addresses is accessed by the client. When a matching IP address is accessed, a process ID of the application used to access the accessed IP address is sent to a client application. A criteria based on the process ID is created, and the criteria is sent to a file system driver for controlling access (reading, writing, creating) of the client to information from the IP address.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates an exemplary embodiment of a system for securely managing data in a client-server application environment in accordance with the present invention;

FIG. 2 illustrates an exemplary embodiment of a client application in accordance with the present invention;

FIG. 3 illustrates an exemplary embodiment of a system for creating a new criteria, in accordance with the present invention;

FIG. 4 illustrates an exemplary embodiment of a method for securely managing data in a client-server application environment, in accordance with the present invention; and

FIG. 5 illustrates another exemplary embodiment of a method for securely managing data in a client-server application environment, in accordance with the present invention.

### DETAILED DESCRIPTION OF THE EXEMPLARY EMBODIMENTS

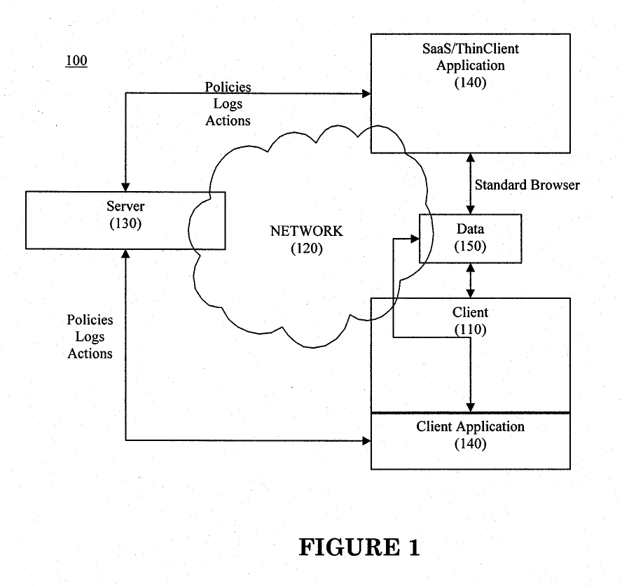

FIG. 1 illustrates an exemplary embodiment of a system for securely managing data in a client-server application environment in accordance with the present invention. The system 100 includes a client 110, a network 120 and a server 130. The client 110 may be a computer or other type of processing device, such as a client-server computer. The network 120 may be any type of network that connects hardware and/or software, such as a local area network (LAN), wireless area network (WAN), etc. The network may be the Internet, for example. The server 130 delivers applications, drivers, DLLs, etc. to the client 110. Also, the server 130 transmits/receives policies, logs and actions to/from the client 110 via a client application 140.

Policies can be used and/or created for an application to define an association between multiple data, such as associating a process ID with a particular IP address. Logs can be used to keep a record of data accessed by the client 110. Actions define a plurality of operations that can be performed when criteria are matched. Examples of actions include allowing a file to be opened, blocking the opening of a file, encrypting a file, redirecting/copying a file to a specified file path, and securing/moving a file to a secure area. Other actions are possible as well. As further described below, a criteria may be an IP address that is accessed by a client-server application.

Also, a Software as a Service (SaaS)/client-server application 150 can receive policies, logs and actions from the server 150. The client-server application 150 is accessed via the network 120. For example, a standard web browser, such as Internet Explorer or Firefox, may be used to access the client-server application 150 via the Internet. Data 160 from the network 120 may be provided to the client-server application 150 and the client 110.

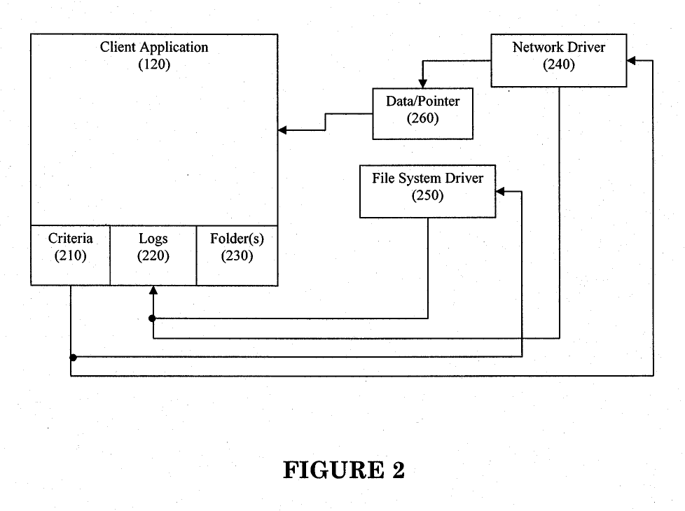

FIG. 2 illustrates an exemplary embodiment of a client application in accordance with the present invention. The client application 140 includes criteria 210, logs 220 and folders 230. The client application 140 receives information from the server 130 to facilitate functioning of the client 110. The information may include, for example, a list of IP addresses associated with a website that would be obtained from public DNS registration information. This information would be regularly updated from publicly available sources and/or from the owners of the IP addresses. The server 130 pushes the IP address list into the client 110, where it may be stored as criteria for a network driver 240 (e.g., a network filter driver). In particular, the network driver may be an NDIS driver, block driver, IFS filter driver, or the like. The client application 140 may load the criteria into the network driver 240 on start-up, after which the network driver 240 monitors network connections to determine when an IP address from the list is accessed.

When an IP address is accessed, the process ID (PID) of the application through which the IP address is connected (e.g., Firefox) is sent back to the client application for further processing. In particular, a new criteria may be created based on the PID and that new criteria may be sent to a file system driver 250. Thus, the file system driver may also receive criteria from the client application 140.

The network driver 240 and the file system driver 250 send log information to the client application, where it may be stored in logs 220. Additionally, the folders 230 may be used to store any particular data or files of interest. Also, the network driver 240 and the file system driver 250 send data and/or pointer 260 to the client application, based on the monitoring performed by the network driver 240 and the file system driver 250, which is based on the criteria.

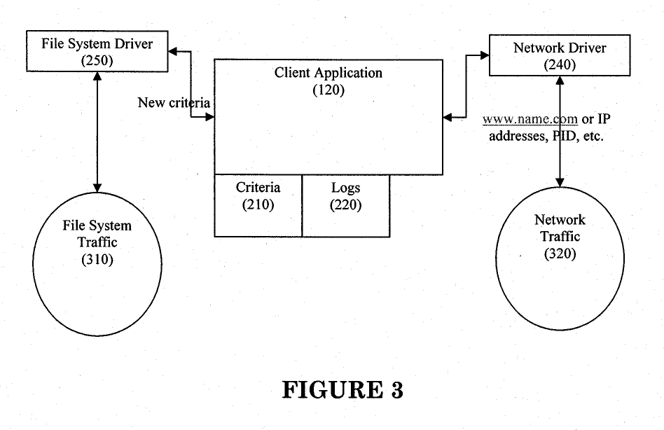

FIG. 3 illustrates an exemplary embodiment of a system for creating a new criteria, in accordance with the present invention. As illustrated in FIG. 3, file system traffic 310 is monitored by the file system driver 250, and network traffic 320 is monitored by the network driver 240. The file system traffic 310 may include, for example, writing and/or reading of files by the client-server application 150. As described above, new criteria based on the PID of the application connecting the client 110 to the client-server application 150 can be sent from the client application 140 to the file system driver 250 to control the file system traffic 310. The network driver 240 may monitor the network traffic 320 for IP addresses, PIDs, or other criteria chosen by the user.

A connection state may be defined as connected, not connected, or connected to a particular IP address (e.g., salesforce.com). When connected to a particular IP address, the client application can create or use policies specific to that state. For example, if PID 123=Firefox and the connection is to 1.1.2.3 (i.e., Bank of America), a policy can be created that states that PID 123 can only have one connection and the connection must be to 1.1.2.3. Another policy that can be implemented, for example, is the intercepting of all file downloads when connected to a particular IP address.

The client application 140 can be used to delete files, folders, and/or applications from the client 110. In other words, a policy can be implemented such that the server 130 sends a message to the client 110 to perform a specific deletion operation of files, folders and/or applications, when, for example, it is determined that an employee that previously used the client is no longer allowed access to the client (e.g., when an employee stops working for a particular employer). Performing the deletion operation can prevent the former user from gaining access to information that could be compromised if access were allowed, thereby providing improved security for that information.

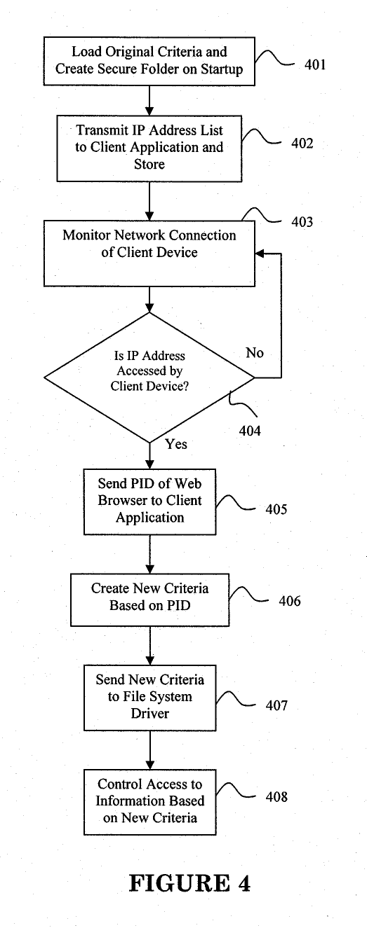

FIG. 4 illustrates an exemplary embodiment of a method for securely managing data in a client-server application environment, in accordance with the present invention. In step 401, original criteria may be loaded and a secure folder may be created upon start-up of the client 110 and/or client application 140. A list of IP addresses for monitoring by the network driver 240 may be transmitted to the client application 140 and stored therein, in step 402. In step 403, the network connections of the client device are monitored so that a determination can be made whether an IP address from the list has been accessed. In step 404, if it is determined that none of the IP addresses in the list have been accessed, the monitoring continues in step 403.

On the other hand, if in step 404 it is determined that one of the IP addresses has been accessed by the client device, the PID of the application used to connect to the IP address may be sent to the client application in step 405. In step 406, a new criteria can be created based on the PID. The new criteria can be sent to the file system driver 250 in step 407. The file system driver 250 can control access to information in the file system traffic 310 in step 408, based on the new criteria.

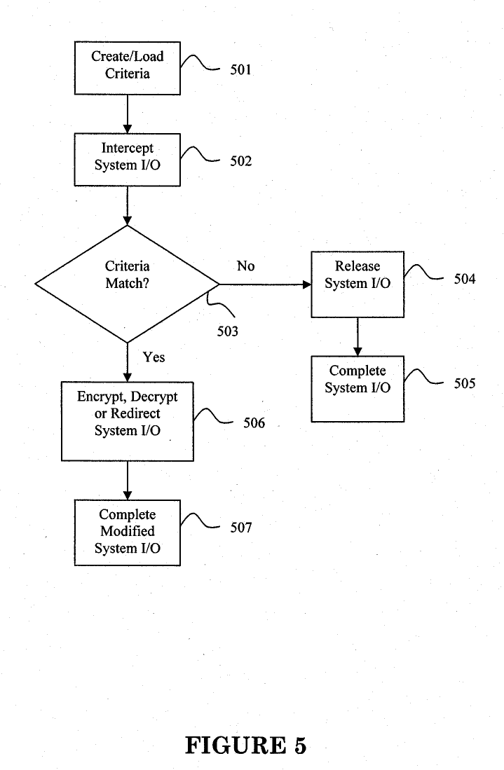

FIG. 5 illustrates another exemplary embodiment of a method for securely managing data in a client-server application environment, in accordance with the present invention. Criteria for monitoring the network traffic 320 and/or the file system traffic 310 may be loaded and/or created in step 501. In step 502, a system I/O of the operating system of the client 110 may be intercepted by the network driver 240. In step 503, it is determined whether the system I/O matches the criteria (e.g., an IP address). If there is not a criteria match, then in step 504, the system I/O is released by the network driver 240 back to the operating system. In step 505, the system I/O is then completed as it would have been if it had not been intercepted.

On the other hand, if it is determined in step 503 that there is a criteria match, then in step 506 the system I/O is encrypted, decrypted or redirected. If the system I/O is to be encrypted or decrypted, it is sent to an encrypt/decrypt function or driver. Using an encryption such as AES, 3DES, Blowfish, or the like, the system I/O (i.e., file) can be encrypted/decrypted in stream, thereby modifying the system I/O. After the encryption/decryption is complete, the modified system I/O is returned to the operating system and completed in step 507. If the system I/O is to be redirected, the system I/O is sent to a redirector function or driver where the I/O file destination is changed. The modified system I/O with the new destination is sent back to the system for completion of the modified system I/O (i.e., file write operation) in step 507.

While the invention has been described in connection with various embodiments, it will be understood that the invention is capable of further modifications. This application is intended to cover any variations, uses or adaptation of the invention following, in general, the principles of the invention, and including such departures from the present disclosure as, within the known and customary practice within the art to which the invention pertains.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for securely managing data in a client-server environment, comprising the acts of:
monitoring a network connection of a client device;
determining when one of a plurality of IP addresses is accessed by the client device;
sending a process ID of a web browser used to access the accessed IP address to a client application;
creating a criteria based on the process ID; and
sending the criteria to a file system driver for controlling access of the client device to information from the IP address.

2. The method of claim 1, further comprising the act of:
transmitting a list of the plurality of IP addresses from a server to the client application.

3. The method of claim 2, further comprising the act of:
storing the IP address list in the client application.

4. The method of claim 1, further comprising the act of:
loading original criteria into a network driver upon start-up.

5. The method of claim 1, further comprising the act of:
creating a secure folder during start-up of the client application.

6. The method of claim 5, wherein downloaded data are pushed from an original storage location to the secure folder.

7. The method of claim 5, wherein downloaded data are downloaded to the secure folder.

8. The method of claim 1, wherein the criteria prevents executable files from being copied from an external drive to an internal drive of a computer on which the client application is stored.

9. The method of claim 1, further comprising the act of:
preventing the client device from accessing applications that can read data from the accessed IP address.

10. A method for securely managing data in a client-server environment, comprising the acts of:
intercepting a system I/O of an operating system;
determining whether the system I/O includes information that matches predetermined criteria of a client-server application;
when a criteria match is determined to not exist, releasing the system I/O for completion by the operating system; and
when a criteria match is determined to exist, performing at least one of encryption, decryption and redirection of the system I/O to produce a modified system I/O prior to allowing completion of the modified system I/O.

11. The method of claim 10, wherein, when the redirection is performed, a destination of a file included in the system I/O is changed.

12. The method of claim 10, wherein, when the redirection is performed, the system I/O is passed to a redirect function or redirect driver where a destination of the system I/O is modified to produce the modified system I/O.

13. The method of claim 10, wherein, when the encryption or decryption is performed, the system I/O is passed to an encrypt or decrypt function or driver and the system I/O is encrypted or decrypted to produce the modified system I/O.

14. The method of claim 10, further comprising the act of:
creating a policy for a client-server application that associates a process ID with an IP address.

15. The method of claim 14, further comprising the act of:
intercepting file downloads from the IP address.

16. The method of claim 10, further comprising the act of:
sending a message from a server to a client to delete at least one of a file, a folder and an application.

17. A system for securely managing data in a client-server environment, comprising:
a network that connects devices in the client-server environment including a devices configured to access the network;
a server configured to communicate with client applications to send criteria to clients and receive logs from the clients in the client-server environment; and
a client device that includes a client application configured to receive criteria, act on the criteria and provide logs of activity back to the server the criteria including a plurality of IP addresses
wherein the network driver monitors network connections of the client device to determine when one of the plurality of IP addresses is accessed.

18. The system of claim 17, wherein the client application loads the criteria into a network driver upon startup.

19. The system of claim 17, wherein, when the IP address is accessed, a process ID of an application connecting the client device to the IP address is sent to the client application, the client application creates a new criteria based on the process ID, and the new criteria is sent to a file system driver.

20. The system of claim 17, wherein a secure folder is created during start-up of the client application.
